(19) United States
(12) Patent Application Publication
(10) Pub. No.: US 2026/0118732 A1
(43) Pub. Date: Apr. 30, 2026

(54) OPTICAL ELEMENT AND LIGHTING DEVICES INCLUDING THE OPTICAL ELEMENT

(71) Applicant: Japan Display Inc., Tokyo (JP)

(72) Inventors: Takeo KOITO, Tokyo (JP); Kojiro IKEDA, Tokyo (JP)

(21) Appl. No.: 19/003,835

(22) Filed: Dec. 27, 2024

Related U.S. Application Data
(63) Continuation of application No. PCT/JP2023/023319, filed on Jun. 23, 2023.

(30) Foreign Application Priority Data
Aug. 31, 2022 (JP) 2022-138571

(51) Int. Cl. G02F 1/29

(52) U.S. Cl. CPC G02F 1/29

(57) ABSTRACT

An optical element includes a liquid crystal cell, a λ/4 film over the liquid crystal cell, and a reflector over the λ/4 film. The liquid crystal cell includes a plurality of first electrodes, a first orientation film over the plurality of first electrodes, a liquid crystal layer over the first orientation film, a second orientation film over the liquid crystal layer, and a plurality of second electrodes over the second orientation film. The plurality of first electrodes extends in a first extending direction and is arranged in a stripe shape. The liquid crystal layer includes liquid crystal molecules. The plurality of second electrodes is arranged in a stripe shape and extends in a second extending direction intersecting the first extending direction at an angle equal to or larger than 80° and equal to or smaller than 90°.

### CROSS-REFERENCE TO RELATED APPLICATIONS

This application is a Continuation of International Patent Application No. PCT/JP2023/023319, filed on June 23, 2023, which claims the benefit of priority to Japanese Patent Application No. 2022-138571, filed on August 31, 2022, the entire contents of which are incorporated herein by reference.

### FIELD

An embodiment of the present invention relates to an optical element and a lighting device including the optical element. For example, an embodiment of the present invention relates to a lighting device including a light source and an optical element capable of arbitrarily controlling an illuminated area of light from the light source.

### BACKGROUND

Application of an electric field to a liquid crystal such as nematic liquid crystal to control the orientation of liquid crystal molecules makes it possible to change the refractive index of the liquid crystal. For example, Japanese Patent Application Publications No. S62-170933 and 2010-230887 disclose liquid crystal lenses utilizing this feature. In these liquid crystal lenses, a liquid crystal is disposed between a pair of electrodes, where at least one of the electrodes is composed of a plurality of concentrically arranged electrodes. The shape of the illuminated area of the light passing through or reflected on the liquid crystal lens can be changed by controlling the AC voltage applied between the pair of electrodes.

### SUMMARY

An embodiment of the present invention is an optical element including a liquid crystal cell, a λ/4 film over the liquid crystal cell, and a reflector over the λ/4 film. The liquid crystal cell includes a plurality of first electrodes, a first orientation film over the plurality of first electrodes, a liquid crystal layer over the first orientation film, a second orientation film over the liquid crystal layer, and a plurality of second electrodes over the second orientation film. The plurality of first electrodes extends in a first extending direction and is arranged in a stripe shape. The liquid crystal layer includes liquid crystal molecules. The plurality of second electrodes is arranged in a stripe shape and extends in a second extending direction intersecting the first extending direction at an angle equal to or larger than 80° and equal to or smaller than 90°.

An embodiment of the present invention is an optical element including a first liquid crystal cell, a second liquid crystal cell over the first liquid crystal cell, and a reflector over the second liquid crystal cell. Each of the first liquid crystal cell and the second liquid crystal cell includes a plurality of first electrodes arranged in a stripe shape, a first orientation film over the plurality of first electrodes, a liquid crystal layer located over the first orientation film and including liquid crystal molecules, a second orientation film over the liquid crystal layer, and a plurality of second electrodes over the second orientation film. In each of the first liquid crystal cell and the second liquid crystal, the plurality of second electrodes is arranged in a stripe shape and intersects the plurality of first electrodes at an angle equal to or larger than 80° and equal to or smaller than 90°.

An embodiment of the present invention is a lighting device including the aforementioned optical element and a light source configured to irradiate the reflector through the liquid crystal cell or through the first liquid crystal cell and the second liquid crystal cell.

### BRIEF DESCRIPTION OF DRAWINGS

FIG. 1 is a schematic perspective view of a lighting device according to an embodiment of the present invention.

FIG. 2 is a schematic cross-sectional view of a lighting device according to an embodiment of the present invention.

FIG. 3 is a schematic cross-sectional view of a light source of a lighting device according to an embodiment of the present invention.

FIG. 4 is a schematic perspective view of a portion of an optical element according to an embodiment of the present invention.

FIG. 5A is a schematic cross-sectional view of an optical element according to an embodiment of the present invention.

FIG. 5B is a schematic cross-sectional view of an optical element according to an embodiment of the present invention.

FIG. 6A is a schematic top view of first electrodes of an optical element according to an embodiment of the present invention.

FIG. 6B is a schematic top view of first electrodes of an optical element according to an embodiment of the present invention.

FIG. 6C is a schematic top view of first electrodes of an optical element according to an embodiment of the present invention.

FIG. 7A is a schematic cross-sectional view of a portion of an optical element according to an embodiment of the present invention.

FIG. 7B is a schematic cross-sectional view of a portion of an optical element according to an embodiment of the present invention.

FIG. 8A is a schematic cross-sectional view for explaining an operation of an optical element according to an embodiment of the present invention.

FIG. 8B is a schematic cross-sectional view for explaining an operation of an optical element according to an embodiment of the present invention.

FIG. 9 is a schematic view for explaining an operation of an optical element according to an embodiment of the present invention.

FIG. 10A is a schematic cross-sectional view for explaining an operation of an optical element according to an embodiment of the present invention.

FIG. 10B is a schematic cross-sectional view for explaining an operation of an optical element according to an embodiment of the present invention.

FIG. 11 is a schematic view for explaining an operation of an optical element according to an embodiment of the present invention.

FIG. 12 is a schematic perspective view for explaining an operation of an optical element according to an embodiment of the present invention.

FIG. 13 is a schematic perspective view of a portion of an optical element according to an embodiment of the present invention.

FIG. 14A includes a timing chart showing a driving method of a lighting device according to an embodiment of the present invention and a schematic view demonstrating an illuminated area obtained by the driving method.

FIG. 14B includes a timing chart showing a driving method of a lighting device according to an embodiment of the present invention and a schematic view demonstrating an illuminated area obtained by the driving method.

FIG. 14C includes a timing chart showing a driving method of a lighting device according to an embodiment of the present invention and a schematic view demonstrating an illuminated area obtained by the driving method.

FIG. 15A includes a timing chart showing a driving method of a lighting device according to an embodiment of the present invention and a schematic view demonstrating an illuminated area obtained by the driving method.

FIG. 15B includes a timing chart showing a driving method of a lighting device according to an embodiment of the present invention and a schematic view demonstrating an illuminated area obtained by the driving method.

FIG. 16 is a schematic cross-sectional view of an optical element according to an embodiment of the present invention.

FIG. 17 is a schematic cross-sectional view of an optical element according to an embodiment of the present invention.

FIG. 18 is a schematic cross-sectional view of an optical element according to an embodiment of the present invention.

FIG. 19A is a schematic perspective view of a portion of an optical element according to an embodiment of the present invention.

FIG. 19B is a schematic top view of a portion of an optical element according to an embodiment of the present invention.

FIG. 20A is a schematic perspective view of a portion of an optical element according to an embodiment of the present invention.

FIG. 20B is a schematic top view of a portion of an optical element according to an embodiment of the present invention.

FIG. 21 is a schematic perspective view for explaining an operation of an optical element according to an embodiment of the present invention.

FIG. 22 is a schematic perspective view of a portion of an optical element according to an embodiment of the present invention.

FIG. 23 includes a timing chart showing a driving method of a lighting device according to an embodiment of the present invention and a schematic view demonstrating an illuminated area obtained by the driving method.

FIG. 24 is a schematic cross-sectional view of an optical element according to an embodiment of the present invention.

FIG. 25 is a schematic perspective view for explaining an operation of an optical element according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate. Similarly, the reference number is used when plural structures which are the same as or similar to each other are collectively represented, while a hyphen and a natural number are further used when these structures are independently represented.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the specification and the claims, an expression “a structure is exposed from another structure” means a mode in which a part of the structure is not covered by the other structure and includes a mode where the part uncovered by the other structure is further covered by another structure. In addition, a mode expressed by this expression includes a mode where a structure is not in contact with other structures.

### First Embodiment

In this embodiment, a lighting device 100 including an optical element 120 according to an embodiment of the present invention is explained.

### Overall Structure

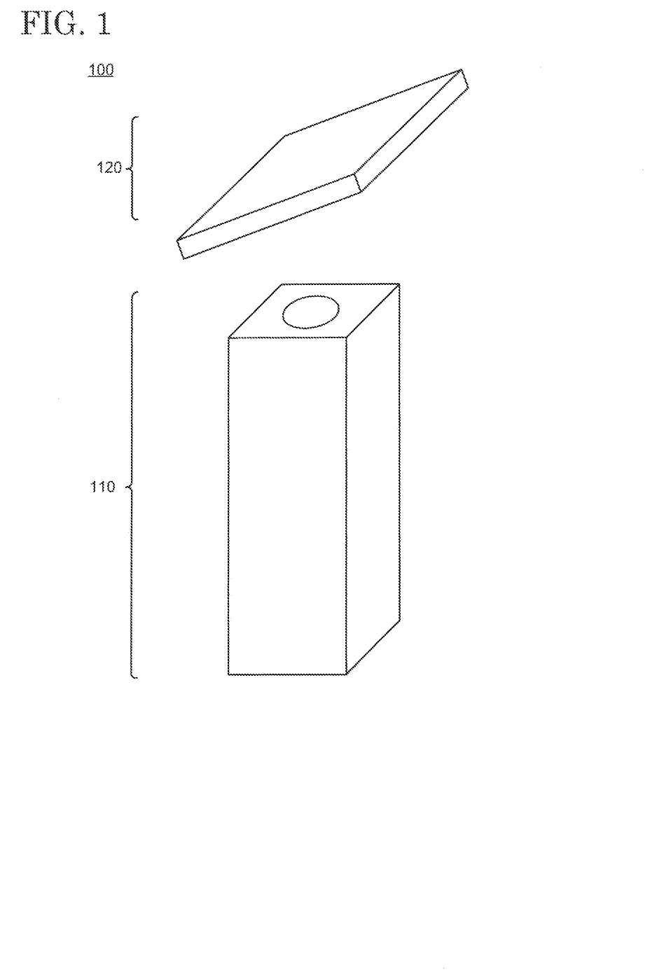

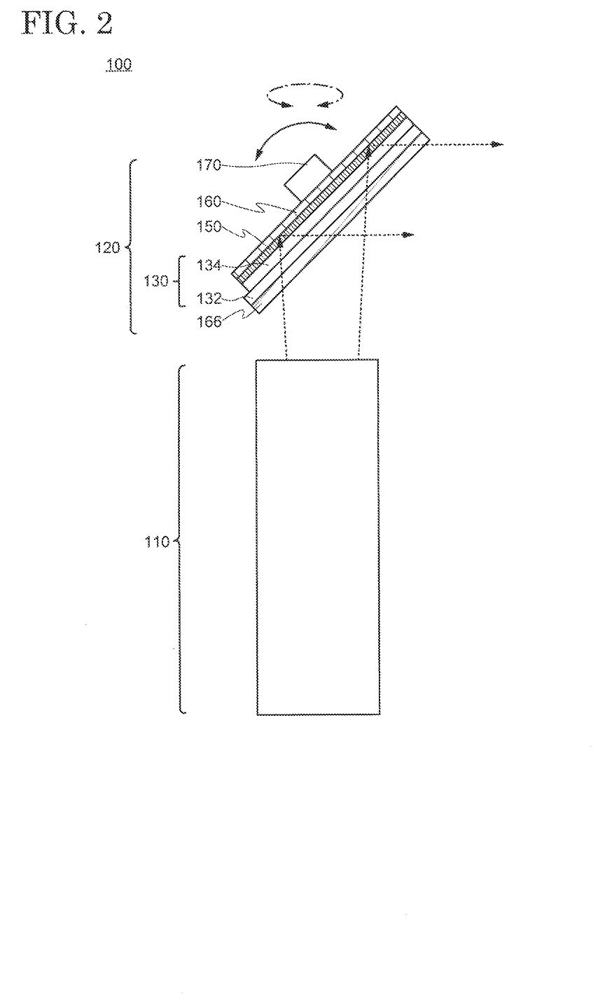

A schematic perspective view and a side view of the lighting device 100 are respectively shown in FIG. 1 and FIG. 2. As shown in these drawings, the lighting device 100 has a light source 110 and an optical element 120 as fundamental components, where the optical element 120 has a λ/4 film 150 and a reflector 160 in addition to a liquid crystal cell 130. The total number of liquid crystal cells 130 included in the optical element 120 is 1. As an optional component, the optical element 120 may have a rotation mechanism 170 or the like to change the angle of the liquid crystal cell 130 with respect to the light source 110. As described below, the liquid crystal cell 130 of the optical element 120 is irradiated with relatively highly directional light (collimated light) emitted from the light source 110, and the light source 110 and the optical element 120 are arranged so that the light from the light source 110 is reflected by the reflector 160 after passing through the liquid crystal cell 130 and the reflected light passes through the liquid crystal cell 130 again (see the dotted arrows in FIG. 2). This arrangement allows the light from the light source 110 to be simultaneously diffused and reflected by the optical element 120.

### Light Source

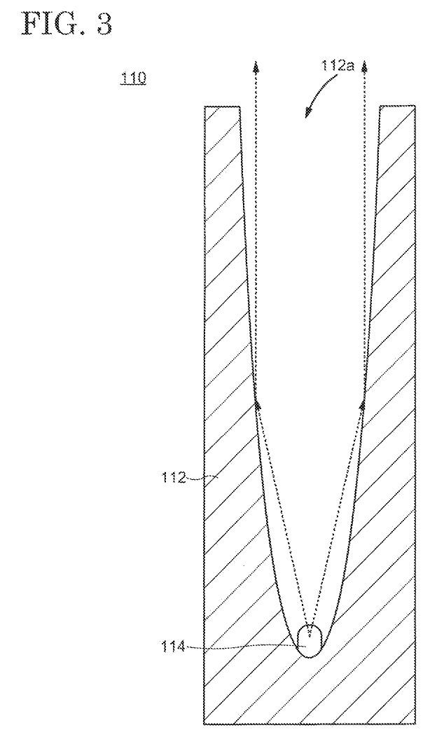

A schematic cross-sectional view of the light source 110 is shown in FIG. 3. The light source 110 has a main body 112, and a recessed portion 112a is formed in the main body. The recessed portion 112a is a bottomed hole, and one or a plurality of light-emitting elements 114 are provided in the recessed portion 112a. The recessed portion 112a has a function of imparting directionality to the light emitted from the light-emitting element 114 to irradiate the optical elements 120 with the light. The main body 112 may be configured to include, for example, a metal such as aluminum and stainless steel, a polymer such as a polyimide, a polycarbonate, and an acrylic resin, or an inorganic oxide such as glass. However, in order to reflect and collect the light from the light-emitting element 114 in the recessed portion 112a and direct the light to the optical element 120 as shown by the dotted arrows in FIG. 3, when the main body 112 is composed of a material transmitting visible light or a material with low reflectance to visible light such as glass or a polymer, the surface of the recessed portion 112a is preferably composed of a film with a high reflectance to visible light. Examples of such a film include a film containing a metal such as aluminum, silver, gold, chromium, and stainless steel or a laminate of thin films containing a material with a high refractive index such as titanium oxide and tantalum oxide and thin films containing a material with a low refractive index such as silicon oxide and magnesium fluoride. The shape of the recessed portion 112a is appropriately adjusted to obtain highly directional light from the light-emitting element 114 in the recessed portion 112a. The optical element 120 is provided to overlap the recessed portion 112a so that the light from the light source 110 is applied (see FIG. 2) and is accommodated together with the light source 110 in a housing which is not illustrated.

The light-emitting element 114 is an element emitting light by supplying an electric current, and there are no restrictions on the structure thereof. A typical example is a light-emitting diode (LED). A light-emitting diode has, as fundamental components, an electroluminescence element in which an inorganic emitter such as gallium nitride and gallium nitride containing indium is sandwiched by a pair of electrodes and a protective film protecting the electroluminescence element and is configured to emit visible light by electroluminescence.

The emission color of the light-emitting element 114 may also be arbitrarily selected. For example, one or a plurality of light-emitting elements 114 providing white light emission may be provided in the recessed portion 112a. Alternatively, a red-emissive light-emitting element 114, a green-emissive light-emitting element 114, and a blue-emissive light-emitting element 114 may be provided in the recessed portion 112a to allow the light source 110 to provide light of a variety of colors from the recessed portion 112a.

There is no restriction on the size of the light-emitting element 114. For example, a light-emitting diode with a footprint area equal to or larger than 1.0 × 10^{４} μm^{２} and equal to or smaller than 1.0 × 10^{６} μm^{２}, equal to or larger than 4.0 × 10^{４} μm^{２} and equal to or smaller than 5.0 × 10^{５} μm^{２}, or equal to or larger than 9.0 × 10^{４} μm^{２} and equal to or smaller than 2.5 × 10^{５} μm^{２} may be used. As an example, a so-called micro LED with a size of approximately 320 μm × 300 μm may be used as the light-emitting element 114.

### Liquid Crystal Cell

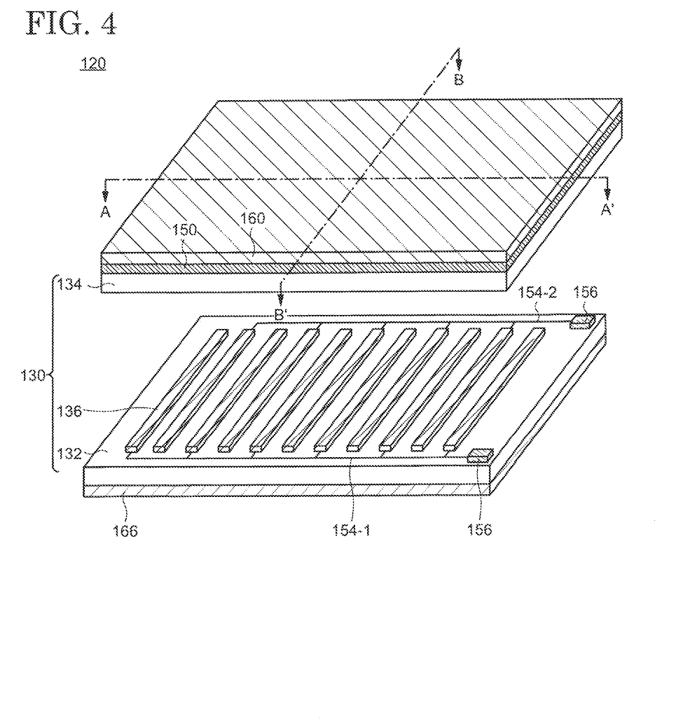

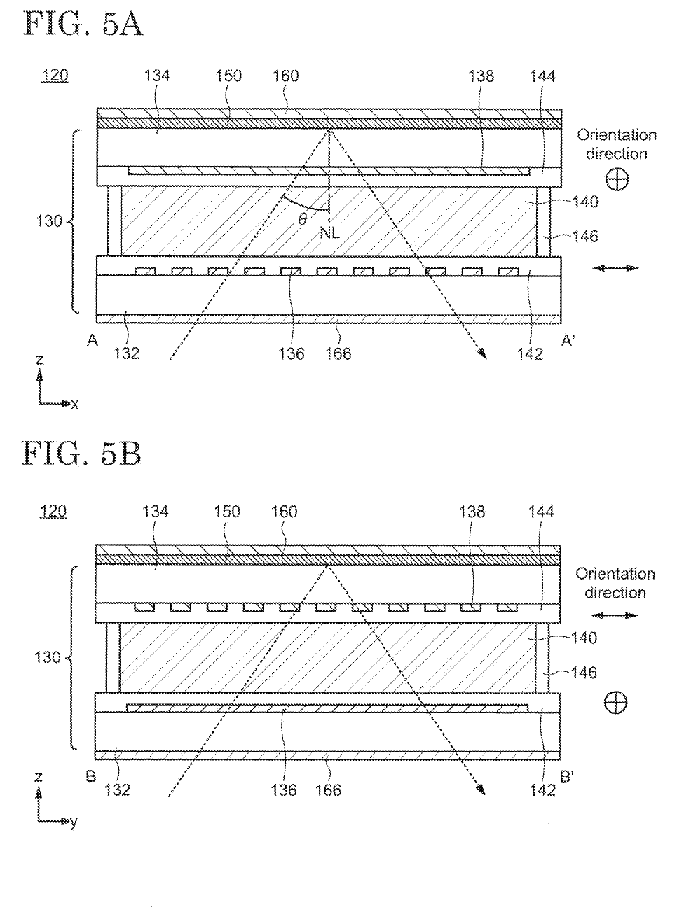

A schematic developed perspective view of the optical element 120 is shown in FIG. 4, and schematic views of the cross sections along the chain lines A-A' and B-B' in FIG. 4 are respectively shown in FIG. 5A and FIG. 5B. In FIG. 4, several components are omitted for visibility. As can be understood from these drawings, the liquid crystal cell 130 includes a substrate 132, a plurality of first electrodes 136 over the substrate 132, a first orientation film 142 over the plurality of first electrodes 136, a liquid crystal layer 140 over the first orientation film 142, a second orientation film 144 over the liquid crystal layer 140, a plurality of second electrodes 138 over the second orientation film 144, and a counter substrate 134 over the plurality of second electrodes 138. In the following description, the main surfaces of the substrate 132 and the counter substrate 134 are defined as a xy plane, and the direction perpendicular to this xy plane is defined as a z- direction.

### (1) Substrate and Counter Substrate

The substrate 132 and the counter substrate 134 are bonded to each other through a frame-shaped sealing material 146. The substrate 132 and the counter substrate 134 serve as a base material for respectively supporting the plurality of first electrodes 136 and the plurality of second electrodes 138 and also encapsulate the liquid crystal layer 140. The substrate 132 and the counter substrate 134 are preferred to include a material exhibiting high transmittance with respect to the light from the light-emitting element 114 so that the light from the light source 110 can pass therethrough. Therefore, it is preferable to configure the substrate 132 and the counter substrate 134 to include, for example, glass, quartz, or a polymeric material such as a polyimide, a polycarbonate, a polyester, or an acrylic resin. The substrate 132 and the counter substrate 134 may be configured to have a sufficient strength so as not to be deformed by external forces or may be configured to be elastically deformed. As shown in FIG. 2, the substrate 132 and the counter substrate 134 may be bonded so that a portion of the main surface of the substrate 132 is exposed from the counter substrate 134.

### (2) First Electrodes and Second Electrodes

As shown in FIG. 4 to FIG. 5B, the plurality of first electrodes 136 is provided over the substrate 132 either in contact with the substrate 132 or through an undercoat which is not illustrated. The undercoat may be formed with one or a plurality of films containing a silicon-containing inorganic compound such as silicon nitride and silicon oxide. The first electrode 136 is preferably formed with a conductive oxide exhibiting high transmittance to visible light such as indium-tin oxide (ITO) or indium-zinc oxide (IZO) in order to provide a high light-transmitting property to the liquid crystal cell 130. The plurality of first electrodes 136 extends in the same direction as each other on the xy plane and is arranged in a stripe shape. The length of each first electrode 136 (length in the extending direction of the first electrodes 136) depends on the size of the optical element 120, but may be selected from a range equal to or longer than 5 cm and equal to or shorter than 15 cm or equal to or longer than 1 cm and equal to or shorter than 10 cm, for example. The spacing between two adjacent first electrodes 136 may be selected from a range equal to or longer than 1 μm and equal to or shorter than 30 μm or equal to or longer than 3 μm and equal to or shorter than 20 μm, for example.

Similarly, the plurality of second electrodes 138 is also provided over the counter substrate 134 (under the counter substrate 134 in FIG. 5A and FIG. 5B) directly or through an undercoat. In order to provide a high light-transmitting property to the liquid crystal cell 130, the second electrodes 138 are also preferably formed with a conductive oxide exhibiting high transmittance to visible light such as ITO or IZO. The plurality of second electrodes 138 also extends in the same direction as each other on the xy plane and is arranged in a stripe shape. The length of each second electrode 138 (length in the extending direction of the second electrode 138) may also be selected from a range equal to or longer than 5 cm and equal to or shorter than 15 cm or equal to or longer than 1 cm and equal to or shorter than 10 cm. In addition, the spacing between two adjacent second electrodes 138 may also be selected from a range equal to or longer than 1 μm and equal to or shorter than 30 μm or equal to or longer than 3 μm and equal to or shorter than 20 μm, for example.

Here, the plurality of first electrodes 136 and second electrodes 138 is provided to intersect each other in the z direction in which these electrodes overlap (i.e., the direction observed from the counter substrate 134 side of the liquid crystal cell 130, also referred to as "in a top view"). The extending direction of the first electrodes 136 and the extending direction of the second electrodes 138 may be perpendicular to each other in the z direction, but it is preferred that these directions are not completely perpendicular. For example, the angle between the extending direction of the first electrodes 136 and the extending direction of the second electrodes 138 in the z direction may be equal to or more than 80° and less than 90°.

As shown in FIG. 4, the first electrodes 136 alternately selected from the plurality of first electrodes 136 are connected to the first wiring 154-1, while the remaining first electrodes 136 are connected to another wiring (second wiring) 154-2 electrically independent from the first wiring 154-1. The first wiring 154-1 and the second wiring 154-2 each form a terminal 156 at the end portion, and the terminals 156 are exposed from the counter substrate 134. Similarly, although not illustrated, the second electrodes 138 alternately selected from the plurality of second electrodes 138 are connected to a wiring (third wiring) which is not illustrated, while the remaining second electrodes 138 are connected to another wiring (fourth wiring). The third wiring and the fourth wiring also form terminals which are not illustrated. Through these terminals, voltages are supplied to the first electrodes 136 and the second electrodes 138 from an external circuit which is not illustrated. With this configuration, the alternately selected first electrodes 136, the other first electrodes 136, the alternately selected second electrodes 138, and the other second electrodes 138 can be independently driven.

A pulsed alternating voltage (alternating square wave) is applied to the plurality of first electrodes 136. However, the alternating voltage is applied so that the phase is reversed between two adjacent first electrodes 136. Similarly, a pulsed alternating voltage is applied to the plurality of second electrodes 138 so that the phase is reversed between two adjacent second electrodes 138. Thus, it is possible to apply the alternating voltage only to the first electrodes 136 while applying no voltage or a constant voltage to the second electrodes 138, and vice versa.

### (3) Liquid Crystal Layer First Orientation Film and Second Orientation Film

Liquid crystal molecules are included in the liquid crystal layer 140. The structure of the liquid crystal molecules is not limited. Although positive nematic liquid crystals are used in this embodiment, smectic liquid crystals, cholesteric liquid crystals, or chiral smectic liquid crystals may be employed. The liquid crystal layer 140 is encapsulated in the space formed by the substrate 132, the counter substrate 134, and the sealing material 146 to be sandwiched between the first orientation film 142 and the second orientation film 144.

The thickness of the liquid crystal layer 140, i.e., the distance between the first orientation film 142 and the second orientation film 144, is also arbitrary adjusted but is preferred to be greater than the pitch of the first electrodes 136 or the second electrodes 138. For example, the thickness of the liquid crystal layer 140 is preferred to be equal to or more than 1.2 times and equal to or less than 10 times, equal to or more than 1.5 times and equal to or less than 5 times, or equal to or more than 1.6 times and equal to or less than 3 times the pitch of the first electrodes 136 or the second electrodes 138. A specific thickness of the liquid crystal layer 140 may be selected from a range equal to or larger than 10 μm and equal to or smaller than 60 μm or equal to or larger than 10 μm and equal to or smaller than 50 μm, for example. Although not illustrated, spacers may be provided in the liquid crystal layer 140 to maintain this thickness throughout the liquid crystal cell 130. Note that, when the aforementioned thickness of the liquid crystal layer 140 is employed in a liquid crystal display device, the high responsiveness required for displaying moving images cannot be obtained, which makes it extremely difficult to express the functions as a liquid crystal display device.

The first orientation film 142 and the second orientation film 144 contain a polymer such as a polyimide and a polyester and sandwich the liquid crystal layer 140. The first orientation film 142 is configured to orient the liquid crystal molecules contained in the liquid crystal layer 140 in a certain direction in a state where no electric field (transverse electric field) exists between adjacent first electrodes 136 (i.e., no voltage is provided to the plurality of first electrodes 136 or no potential difference exists between adjacent first electrodes 136). Similarly, the second orientation film 144 is also configured to orient the liquid crystal molecules contained in the liquid crystal layer 140 in a certain direction in a state where no transverse electric field exists between the plurality of second electrodes 138 (i.e., no voltage is provided to the plurality of second electrodes 138 or no potential difference exists between adjacent second electrodes 138). Hereinafter, the direction in which the first orientation film 142 and the second orientation film 144 orient the liquid crystal molecules in the absence of an electric field is referred to as an orientation direction. The orientation direction can be provided, for example, by a rubbing process. Alternatively, the first orientation film 142 and second orientation film 144 may be provided with the orientation direction by photo-orientation. The photo-orientation is a rubbing-less orientation process using light. For example, an orientation film which has not been subjected to a rubbing process is irradiated with polarized light in the ultraviolet region from a predetermined direction. This process causes a photoreaction in the orientation film, thereby introducing anisotropy to the surface of the orientation film and providing the ability to control liquid crystal orientation.

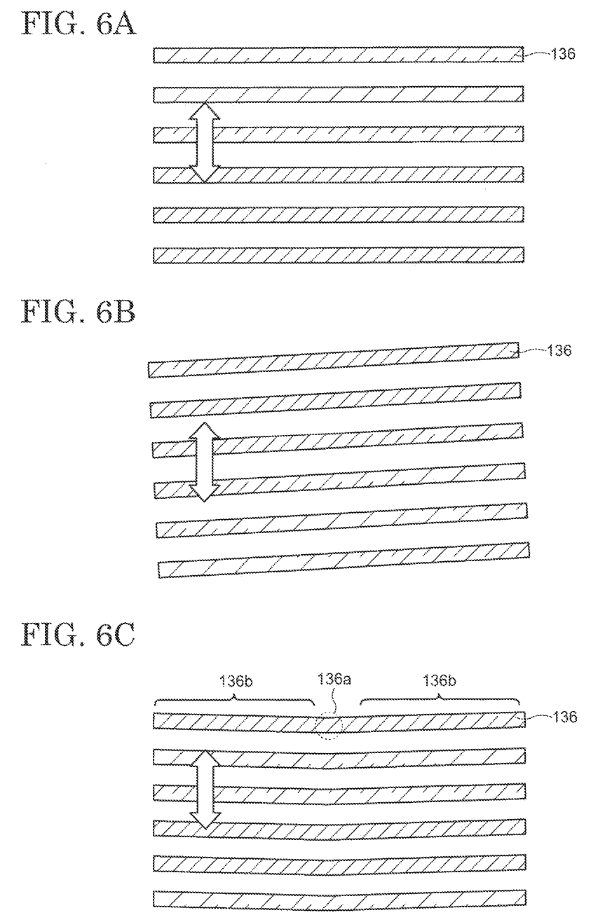

As shown in FIG. 5A and FIG. 5B, the liquid crystal cell 130 is configured so that the orientation directions of the first orientation film 142 and the second orientation film 144 are orthogonal to each other in the z direction or the angle therebetween in the z direction is equal to or larger than 80° and equal to or smaller than 90°. In addition, the plurality of first electrodes 136 and the first orientation film 142 may be arranged so that the extending direction of the plurality of first electrodes 136 and the orientation direction of the first orientation film 142 (see the white arrow) are perpendicular to each other in the z direction as shown in FIG. 6A, or the extending direction of the plurality of first electrodes 136 and the orientation direction of the first orientation film 142 are not completely perpendicular to each other in the z direction as shown in FIG. 6B. In the latter case, the angle between the extending direction of the plurality of first electrodes 136 and the orientation direction of the first orientation film 142 in the z direction may be selected from a range equal to or larger than 80° and smaller than 90° or equal to or larger than 85° and smaller than 90°. Although not illustrated, the same is applied to the relationship between the plurality of second electrodes 138 and the second orientation film 144. That is, the plurality of second electrodes 138 and the second orientation film 144 may be arranged so that the extending direction of the plurality of second electrodes 138 is perpendicular to the orientation direction of the second orientation film 144 in the z direction, or the angle between the extending direction of the plurality of second electrodes 138 and the orientation direction of the second orientation film 144 in the x direction is equal to or larger than 80° and smaller than 90° or equal to or larger than 85° and smaller than 90°.

Herer, the extending direction of each first electrode 136 is a direction from the intersection with the first wiring 154-1 or the second wiring 154-2 to the tip of the first electrode 136, when the entire first electrode 136 has a straight line shape as shown in FIG. 6A. However, each first electrode 136 may have a bending structure including a plurality of straight sections as shown in FIG. 6C. For example, each first electrode 136 may be configured to have a pair of straight sections 136b sandwiching one bending point 136a. In this case, the plurality of first electrodes 136 is arranged so that the angle between the extending direction of at least one straight section 136b and the orientation direction of the first orientation film 142 in the z direction is equal to or larger than 80° and equal to or smaller than 90° or equal to or larger than 85° and equal to or smaller than 90°. The same is applied to the second electrodes 138. That is, the extending direction of each second electrode 138 is a direction from the intersection with the third wiring or the fourth wiring to the tip of the second electrode 138 when the entire second electrode 138 has a straight line shape. Each second electrode 138 may also have a bending structure including a plurality of straight sections, and in this case, the plurality of second electrodes 138 is arranged so that the angle between the extending direction of at least one straight section and the orientation direction of the second orientation film 144 in the z direction is equal to or larger than 80° and equal to or smaller than 90° or equal to or larger than 85° and equal to or smaller than 90°.

### λ4 Film

The λ/4 film 150 is one of the retardation films and is a film providing a phase difference of λ/4 (π/2) between two vertically polarized components of the incident light and emitting this light. The λ/4 film 150 may be formed by applying a stretching orientation treatment onto a polymer with a high transmitting property with respect to visible light such as a polycarbonate, a cycloolefin polymer, and poly(methyl methacrylate) or may be composed of a liquid crystal polymer subjected to an orientation treatment. The λ/4 film may be provided over the counter substrate 134 (opposite side to the liquid crystal layer 140) directly or through an adhesive layer which is not illustrated (see FIG. 4 to FIG. 5B).

### Reflector

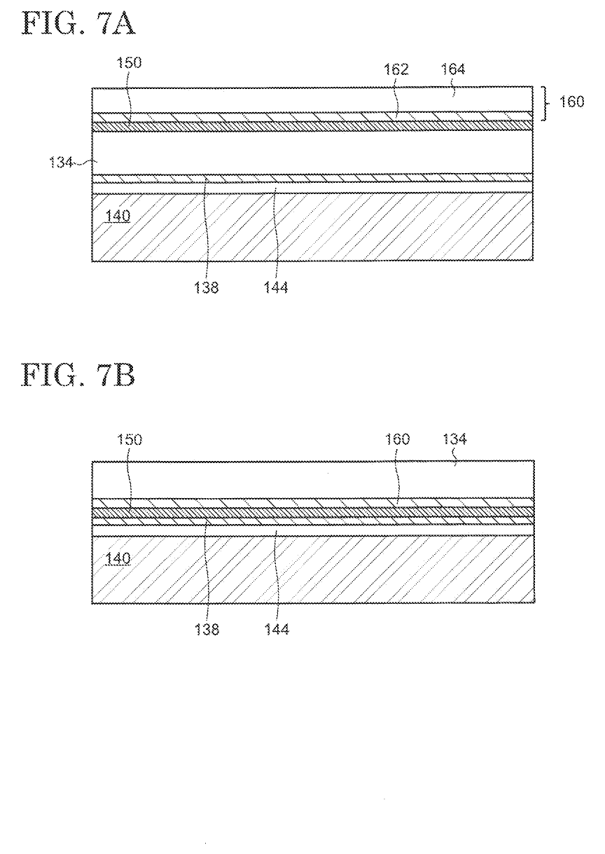

As shown in FIG. 4 to FIG. 5B, the reflector 160 is provided over the λ/4 film 150 and is configured not to transmit but to reflect visible light. Hence, the reflector 160 is formed so as to include a metal having high reflectance in a wide wavelength range in the visible region, such as silver or aluminum, at a thickness which does not allow the visible light to pass therethrough (e.g., 20 nm or more or 50 nm or more). As shown in FIG. 4 to FIG. 5B, the reflector 160 may be formed by bonding a thin film (foil) or a metal plate containing the metal described above to the λ/4 film 150. Alternatively, as shown in FIG. 7A, a laminate including a support substrate 164 containing glass, quartz, or a polymer such as a polycarbonate, a polyester, or a polyimide and a reflective film 162 formed over the support substrate 164 may be bonded to the λ/4 film 150 as the reflector 160. Alternatively, as shown in FIG. 7B, the λ/4 film 150 and the reflector 160 may be arranged between the counter substrate 134 and the second electrodes 138.

### Other Components

As an optional component, the optical element 120 may include the rotation mechanism 170 for changing the angle of the liquid crystal cell 130 with respect to the light source 110 (FIG. 2). The configuration of the rotation mechanism 170 is arbitral as long as it can rotate the optical element 120 about a rotation axis perpendicular to the direction of the light emitted from the light source 110 (or the direction in which the recessed portion 112a extends) (see the solid curved arrow in FIG. 2). Furthermore, the rotation mechanism 170 may be configured to rotate the optical element 120 about a rotation axis parallel to the direction of the light emitted from the light source 110 (see the curved chain arrow in FIG. 2). The light from the light source 110 can be emitted in arbitral directions by providing the rotation mechanism 170.

As shown in FIG. 4 to FIG. 5B, the optical element 120 may further include an antireflection film 166 as a component to prevent the reflection of the light from the light source 110 on the substrate 132 and to allow the light to efficiently reach the reflector 160. The antireflection film 166 is provided over the bottom surface of the substrate 132 (an opposite side to the counter substrate 134). A known antireflection film (AR film) may be used as the antireflection film 166. For example, a laminate of a base film and an antireflection film with different refractive indexes may be used as the antireflection film 166. As an example, a laminate of a fluorine-containing resin or a thin film of silicon dioxide or titanium dioxide deposited over a polymer film exemplified by a polyester such as poly(ethylene terephthalate) or a cellulose such as triacetyl cellulose may be used as the antireflection film 166. The use of the antireflection film 166 prevents the light reflected on the substrate 132 from reaching the illuminated area, by which the shape and size of the illuminated area can be more precisely controlled.

### Arrangement of Optical Element Relative to Light Source

As described below, the light from the light source 110 is diffused in the lighting device 100 when passing through the liquid crystal cell 130 of the optical element 120 twice, which allows the light from the light source 110 to be processed into light providing variously shaped illuminated areas. Hence, the optical element 120 is arranged so that the liquid crystal cell 130 overlaps the recessed portion 112a of the light source 110, the light from the light source 110 is reflected by the reflector 160 after passing through the liquid crystal cell 130 and the λ/4 film 150, and the reflected light passes through the λ/4 film 150 and the liquid crystal cell 130 again (see the dotted arrows in FIG. 2, FIG. 5A, and FIG. 5B). More specifically, the light source 110 and the optical element 120 are arranged so that the light of the light source 110 is applied on the liquid crystal cell 130 at an incident angle equal to or larger than 15° and equal to or smaller than 75°. That is, the light source 110 and the optical element 120 are arranged so that the angle θ between the direction parallel to the normal line NL of the surfaces of the substrate 132, the counter substrate 134, and the reflector 160 (see FIG. 5A) and the travelling direction of the light of the light source 110 (alternatively, the extending direction of the recessed portion 112a) is equal to or larger than 15° and equal to or smaller than 75°. The rotation mechanism 170 may be configured to rotate the liquid crystal cell 130 within this angle.

### Light Distribution Control by Optical Element

The optical element 120 described above diffuses the light emitted from the light source 110 in a certain direction. Therefore, the light from the light source 110 can be processed into an arbitrary shape by appropriately driving the optical element 120, and as a result, the shape of the illuminated area, which is an area where an object is irradiated by the lighting device 100, can be arbitrarily controlled. Hereinafter, the light diffusion in the liquid crystal cell 130 is explained using a mode in which the first electrodes 136 and the second electrodes 138 respectively extend in the x direction and the y direction. In the following description, although a mode is used where the light from the light source 110 is emitted perpendicular to the liquid crystal cell 130, i.e., in the z direction, to promote understanding, it should be noted that the light behaves in the same way when the light is incident on the optical element 120 in a direction deviating from the z direction.

### (1) Non-Driving State

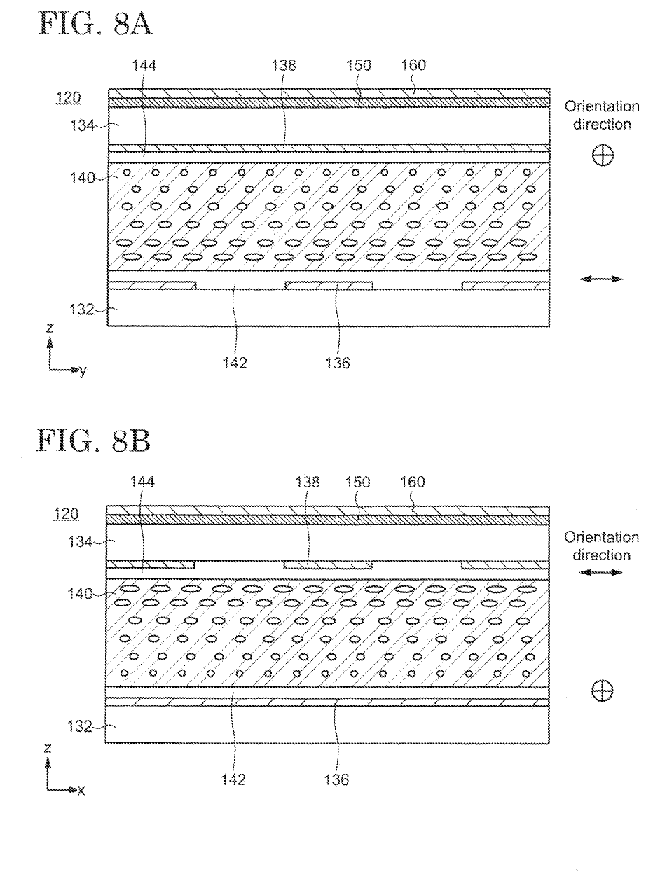

Schematic cross-sectional views of the liquid crystal cell 130 in a non-driving state are shown in FIG. 8A and FIG. 8B. FIG. 8A and FIG. 8B are schematic cross-sectional views respectively observed from the x direction and the y direction. In the following drawings, the liquid crystal molecules are schematically represented as white ovals or circles.

The case in which the liquid crystal cell 130 is not driven is a case where no voltage or a constant voltage is applied to the plurality of first electrodes 136 and the plurality of second electrodes 138. In this case, since no transverse electric field is generated between the plurality of first electrodes 136 and between the plurality of second electrodes 138, the liquid crystal molecules are oriented according to the orientation directions of the first orientation film 142 and the second orientation film 144. The liquid crystal molecules close to the substrate 132 are oriented along the orientation direction of the first orientation film 142 (here, the direction at an angle equal to or larger than 80 ° and equal to or smaller than 90° with respect to the y direction or the x direction) and twist about the z direction as a central axis by 90° as they approach the counter substrate 134.

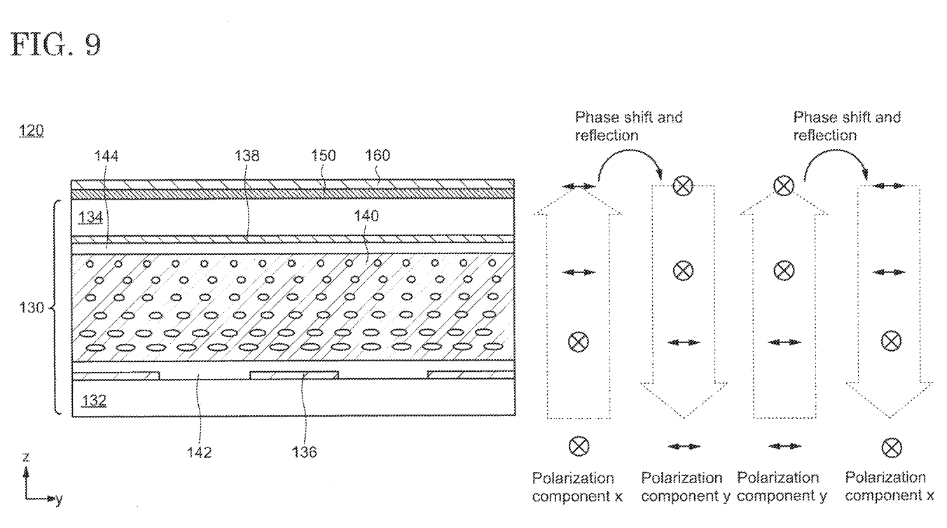

Therefore, the light emitted from the light source 110 does not diffuse but only optically rotates when travelling through the liquid crystal cell 130 toward the reflector 160. Specifically, as shown in FIG. 9, the light with a polarization component in the x direction (polarization component x) from the light source 110 optically rotates 90° when passing through the liquid crystal layer 140 to become light with a polarization component in the y direction (polarization component y). Similarly, the polarization component y perpendicular to the polarization component x also optically rotates 90° to become a polarization component x.

The light then passes through the λ/4 film 150, is further reflected by the reflector 160, and passes through the λ/4 film 150 again. Therefore, since the light which has become the polarization component y by the optical rotation in the liquid crystal layer 140 is phase-shifted by λ/4 twice by the λ/4 film 150, the light becomes the polarization component x phase-shifted by λ/2 (i.e., 90°) and then enters the liquid crystal layer 140 again to undergo optical rotation. As a result, the light which initially enters the optical element 120 as the polarization component x is emitted from the optical element 120 as the reflected light of the polarization component y. Similarly, the light which has become the polarization component x by the optical rotation in the liquid crystal layer 140 becomes the polarization component y when passing through the λ/4 film 150 twice, and then enters the liquid crystal layer 140 again to undergo optical rotation. As a result, the light which initially enters the optical element 120 as the polarization component y is emitted from the optical element 120 as the reflected light of the polarization component x. However, since there is no electric field in the liquid crystal layer 140, no orientation change of the liquid crystal molecules occurs. Therefore, no refractive index distribution is generated in the liquid crystal layer 140, and no light diffusion occurs. Accordingly, when the liquid crystal cell 130 is not driven, the collimated light from the light source 110 is almost negligibly diffused and is emitted from the optical element 120, thereby producing light providing a small illuminated area.

### (2) Driving State

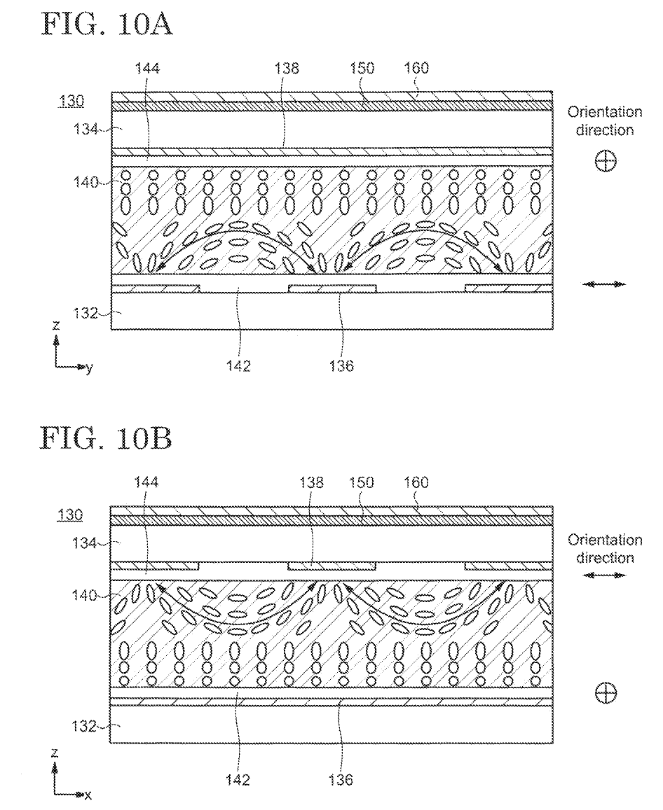

Schematic cross-sectional views of the liquid crystal cell 130 in a driven state are shown in FIG. 10A and FIG. 10B. FIG. 10A and FIG. 10B respectively correspond to FIG. 8A and FIG. 8B. A mode where the liquid crystal cell 130 is driven is a mode where a pulsed alternating voltage is applied to the plurality of first electrodes 136 and the plurality of second electrodes 138 so that the phase is inverted between adjacent first electrodes 136 and between adjacent second electrodes 138. The frequency of the alternating voltage applied to the first electrodes 136 and the second 138 electrodes is the same. The alternating voltage may be selected from a range equal to or higher than 3 V and equal to or lower than 50 V or equal to or higher than 3 V and equal to or lower than 30 V, for example. Since the extending directions of the first electrodes 136 and the second electrodes 138 are orthogonal or intersect at an angle equal to or larger than 80° and smaller than 90°, the application of the alternating voltage generates transverse electric fields between adjacent first electrodes 136 and between adjacent second electrodes 138 which are orthogonal to each other or intersect at an angle equal to or larger than 80° and equal to or smaller than 90° (see the arrows in FIG. 10A and 10B). An electric field (vertical electric field) is also generated between the first electrode 136 and the second 138 electrode. However, the thickness of the liquid crystal layer 140 is greater than the spacing between adjacent first electrodes 136 and between adjacent second electrodes 138. Therefore, the vertical electric field is significantly smaller than the transverse electric field and can be ignored. Thus, each liquid crystal molecule is oriented according to the transverse electric field.

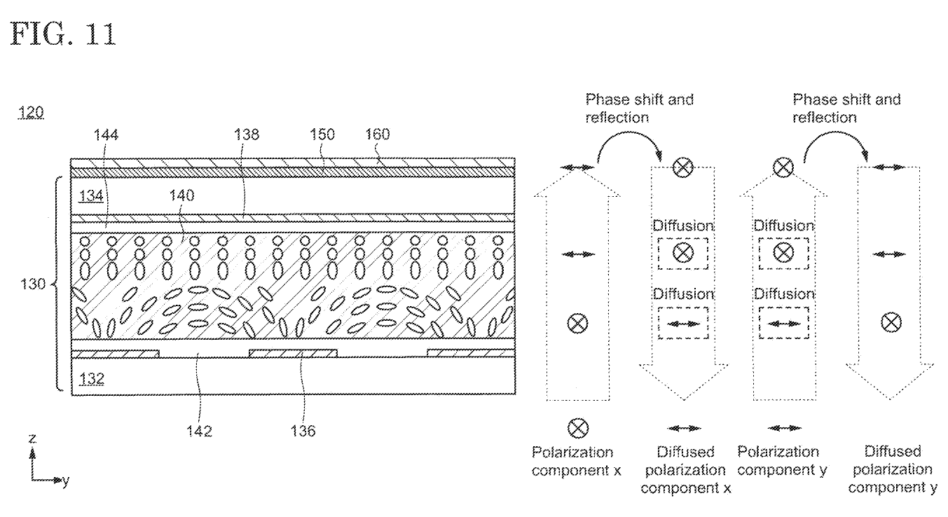

When a transverse electric field is generated in the liquid crystal layer 140, the liquid crystal molecules on the first electrode 136 side orient along the direction of the transverse electric field, while orienting in an upwardly convex arc between adjacent first electrodes 136 (FIG. 10A). The same is applied to the second electrode 138 side, where the liquid crystal molecules are oriented along the direction of the transverse electric field, while orienting in a downwardly convex arc between adjacent second electrodes 138 (FIG. 10B). This orientation change of the liquid crystal molecules creates a refractive index distribution in the liquid crystal layer 140. As a result, as shown in FIG. 11, the polarization component y of the light incident on the liquid crystal layer 140 from the substrate 132 of the liquid crystal cell 130, which is a component parallel to the transverse electric field formed by the first electrodes 136, is refracted by the refractive index distribution formed on the substrate 132 side of the liquid crystal layer 140 and is diffused in the y direction. Since this light becomes the polarization component x, which is a component parallel to the transverse electric field formed by the second electrodes 138 when optically rotated in the liquid crystal layer 140, this light is diffused in the x direction by the refractive index distribution formed on the counter substrate 134 side of the liquid crystal layer 140. In this way, the polarization component y diffuses in the x direction and the y direction when passing through the liquid crystal layer 140 once.

When this light further passes through the λ/4 film 150, is reflected by the reflector 160, and then passes through the λ/4 film 150 again, this light becomes polarization component y and enters the liquid crystal layer 140 again. Since the polarization direction of this polarization component y is orthogonal to or intersects the orientation direction of the liquid crystal molecules formed on the second electrode 138 side of the liquid crystal layer 140 at an angle equal to or larger than 80° and smaller than 90°, this light is negligibly affected by the refractive index distribution and is not substantially diffused. In addition, when this light is changed into the polarization component x by the liquid crystal layer 140, the polarization direction of the polarization component x is orthogonal to or intersects the orientation direction of the liquid crystal molecules formed on the first electrode 136 side of the liquid crystal layer 140 at an angle equal to or larger than 80° and smaller than 90°. Hence, this light is not substantially diffused. With the above mechanism, one polarization component y becomes a polarization component y diffused once in the x-direction and once in the y-direction and is emitted from the optical element 120. The same mechanism works for the polarization component x applied to the optical element 120, and as a result, this polarization component x becomes a polarization component x diffused once in the x direction and the y direction and is emitted from the optical element 120.

As described above, the first electrodes 136 and the second electrodes 138 can be independently driven. Therefore, the refractive index distribution can be formed only on the first electrode 136 or second electrode 138 side of the liquid crystal layer 140, and the diffusion direction and the number of diffusions can be controlled as appropriate.

### (3) Processing of Light

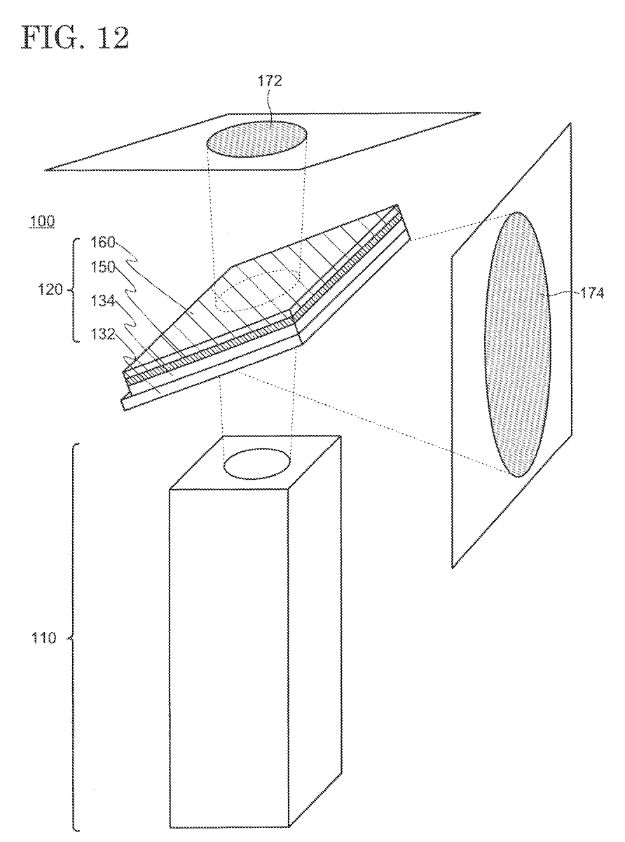

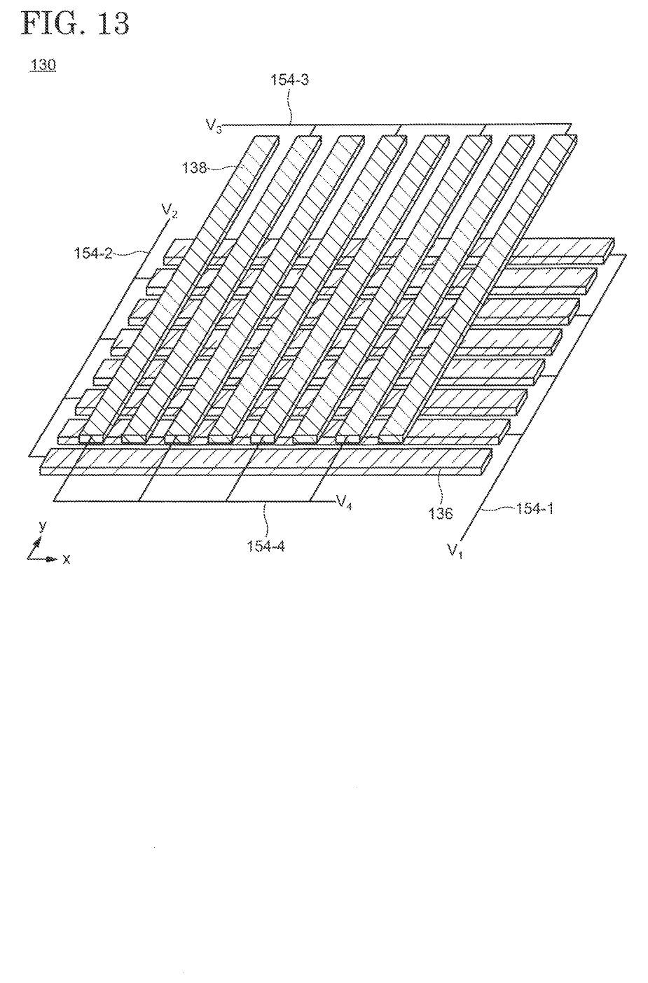

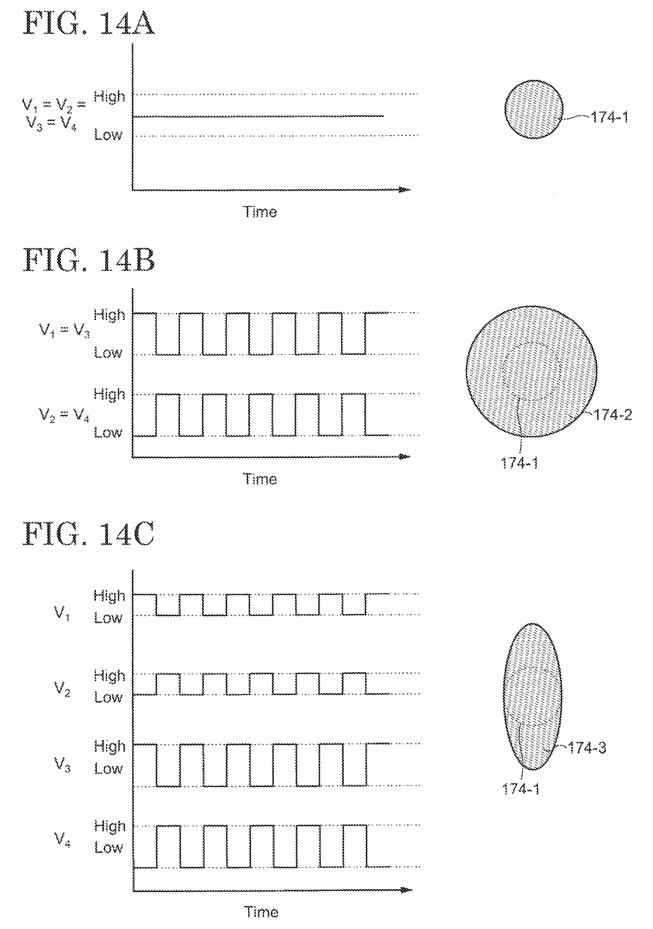

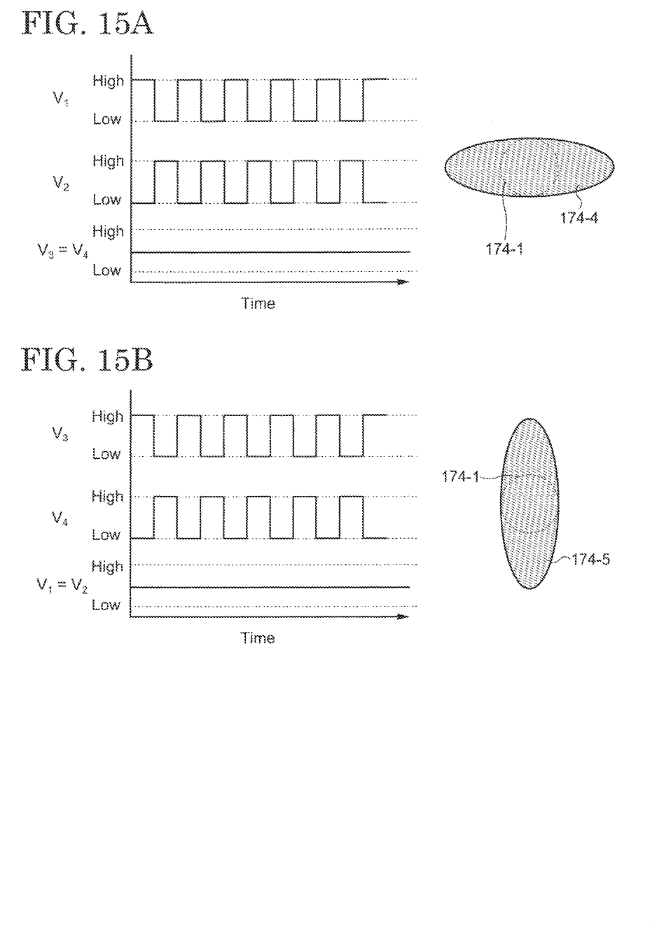

By using this mechanism, an illuminated area 174 can be formed which is greatly enlarged compared with a virtual illuminated area 172 formed by the light source 110 on the illuminated object when assuming that the optical element 120 is absent as shown in FIG. 12. Moreover, the illuminated area can be arbitrarily controlled by controlling the voltage supplied to the first electrodes 136 and the second electrodes 138 as appropriate. For example, consider a case where voltages V₁ and V₂ are alternately supplied to the plurality of first electrodes 136 through the first wiring 154-1 and the second wiring 154-2, while voltages V₃ and V₄ are alternately supplied to the plurality of second electrodes 138 through the third wiring 154-3 and the fourth wiring 154-4 as shown in FIG. 13. Since the liquid crystal cell 130 is in a non-driven state when the voltages V₁, V₂, V₃, and V₄ are set to be 0 or constant, the light provides a relatively narrow illuminated area 174-1 similar to the virtual illuminated area 172 (FIG. 14A). In contrast, the light from the light source 110 can be processed to light providing an illuminated area 174-2 which is evenly diffused in both the x direction and y direction (FIG. 14B) by synchronizing the voltages V₁ and V₃, setting the voltages V₂ and V₄ in an opposite phase with respect to the voltages V₁ or V₃, and setting the voltages V₁, V₂, V₃, and V₄ to be the same. Hence, the illuminated area 174-2 is almost identical in shape to the virtual illuminated area 172, but is larger than the virtual illuminated area 172. Alternatively, the light from the light source 110 can be processed to light providing an illuminated area 174-3 which is more greatly diffused in the x direction than the y direction (FIG. 14C) by synchronizing the voltages V₁ and V₃, setting the voltages V₂ and V₄ in an opposite phase with respect to the voltages V₁ or V₃, and setting the voltages V₁ and V₂ to be smaller than the voltages V₃ and V₄. When the virtual illuminated area 172 is a circle, the illuminated area 174-3 will be an ellipse. Alternatively, the light from the light source 110 can be processed into light providing a vertically elongated illuminated area 174-4 diffused in the y direction by inverting the voltages V₁ and V₂ and setting the voltages V₃ and V₄ to be 0 or constant (FIG. 15A). Conversely, the light from the light source 110 can be processed into light providing a horizontally elongated illuminated area 174-5 diffused in the x direction by inverting the voltages V₃ and V₄ and setting the voltages V₁ and V₂ to be 0 or constant (FIG. 15B).

As described above, in the lighting device 100 of this embodiment, both polarization components of the light from the light source 110 can be individually diffused by using the optical element 120 including a single liquid crystal cell 130. Thus, it is possible to provide illuminated areas with a variety of shapes. Considering that conventional lighting devices require a plurality of liquid crystal cells to diffuse both polarization components of light from a light source, implementation of this embodiment enables not only miniaturization of optical elements but also low-cost production of a lighting device capable of providing a wide variety of illuminated areas.

### Second Embodiment

In this embodiment, an optical element 122 with structures different from those of the optical element 120 described in the First Embodiment is explained. An explanation of the structures the same as or similar to those described in the First Embodiment may be omitted.

### 1. Structure

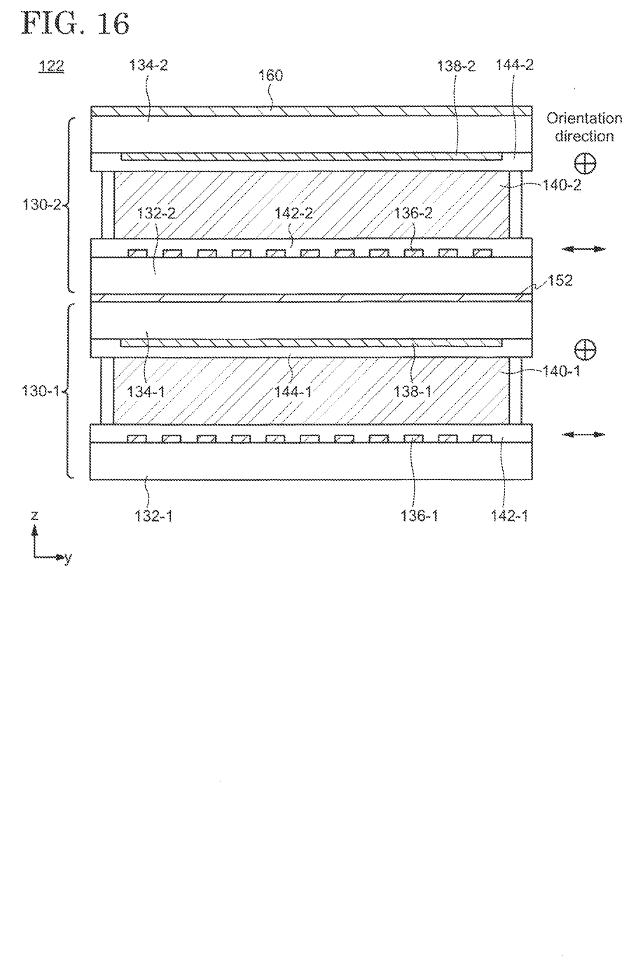

One of the differences of the optical element 122 from the optical element 120 is that the optical element 122 has two liquid crystal cells (first liquid crystal cell 130-1 and second liquid crystal cell 130-2) overlapping each other in the z direction as shown in FIG. 16. In other words, the total number of liquid crystal cells 130 included in the optical element 122 is two. The structures of the first liquid crystal cell 130-1 and the second liquid crystal cell 130-2 may each be identical to the structure of the liquid crystal cell 130 of the optical element 120. The productivity of the optical element 122 can be improved and the optical element 122 as well as the lighting device 100 including the optical element 122 can be provided at a lower cost by using the first liquid crystal cell 130-1 and the second liquid crystal cell 130-2 having the same structure. The first liquid crystal cell 130-1 and the second liquid crystal cell 130-2 are fixed to each other with a light-transmitting adhesive layer 152. The light from the light source 110 is reflected on the reflector 160 after passing through the first liquid crystal cell 130-1 and the second liquid crystal cell 130-2 in this order, passes through the second liquid crystal cell 130-2 and the first liquid crystal cell 130 again in this order, and then is emitted from the optical element 122. Although not illustrated, the optical element 122 may also include the antireflection film 166 on the bottom side of the substrate 132 of the first liquid crystal cell 130-1.

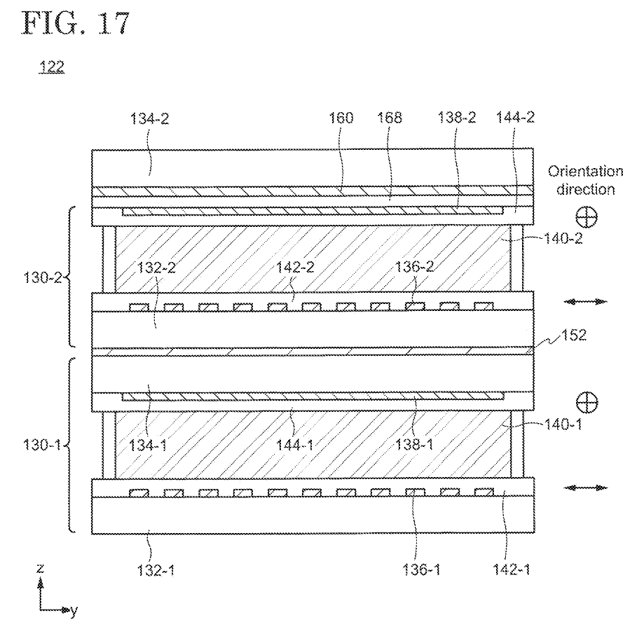

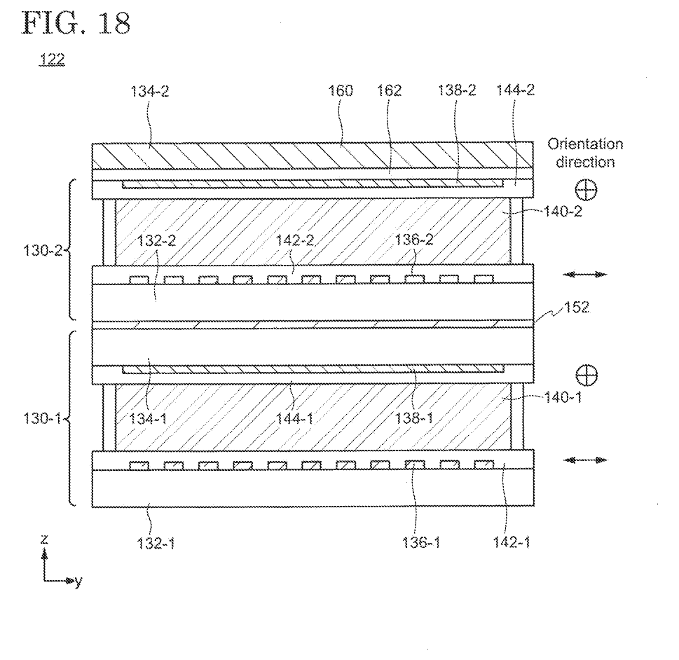

As described below, in the optical element 122, the extending direction of the first electrodes 136-1 of the first liquid crystal cell 130-1 may be parallel to or at an angle equal to or larger than 0° and equal to or less than 10° with respect to the extending direction of the first electrodes 136-2 of the second liquid crystal cell 130-2. Therefore, the extending direction of the second electrodes 138-1 of the first liquid crystal cell 130-1 may also be parallel to or at an angle equal to or larger than 0° and equal to or less than 10° with respect to the extending direction of the second electrodes 138-2 of the second liquid crystal cell 130-2. Furthermore, as shown in FIG. 16, the optical element 122 does not require the λ/4 film 150, and the reflector 160 may be provided over the counter substrate 134 directly or through an adhesive layer which is not illustrated. Alternatively, as shown in FIG. 17, the reflector 160 may be provided, as a reflective layer, between the second electrodes 138-2 and the counter substrate 134-2 of the second liquid crystal cell 130-2. In this case, an insulating layer 168 electrically insulating the reflector 160 and the second electrodes 138-2 from each other may be provided between the reflector 160 and the second electrodes 138-2. The insulating layer 168 may be formed using one or a plurality of films containing, for example, a polymer such as an acrylic resin and an epoxy resin or a silicon-containing inorganic compound such as silicon oxide and silicon nitride. Alternatively, as shown in FIG. 18, the reflector 160 may be used instead of the counter substrate 134-2. In this case, the insulating layer 168 may also be arranged to electrically insulate the reflector 160 and the second electrode 138-2 from each other.

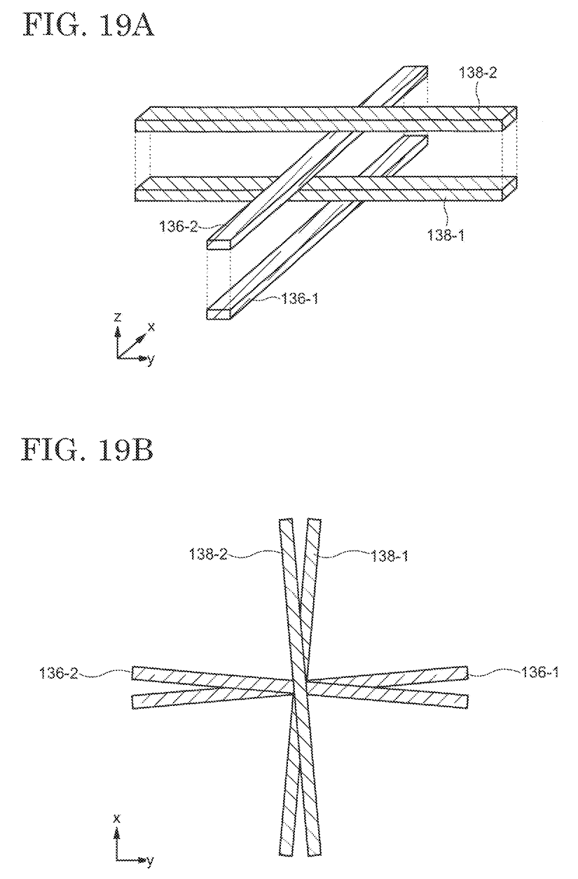

A schematic perspective view and a top view each including one first electrode 136-1 and one second electrode 138-1 selected from the first liquid crystal cell 130-1 as well as one first electrode 136-2 and one second electrode 138-2 selected from the second liquid crystal cell 130-2 are respectively illustrated in FIG. 19A and FIG. 19B. As shown in FIG. 19A, the first electrode 136-1 and the first electrode 136-2 may be parallel to each other, and/or the second electrode 138-1 and the second electrode 138-2 may also be parallel to each other. Alternatively, as shown in FIG. 19B, the directions in which the first electrode 136-1 and the first electrode 136-2 extend may be shifted from each other in the z direction, and similarly, the directions in which the second electrode 138-1 and the second electrode 138-2 extend may be shifted from each other in the z direction. In the case of adopting the arrangement relationship shown in FIG. 19B, the first liquid crystal cell 130-1 and the second liquid crystal cell 130-2 may be configured so that the extending directions of the first electrode 136-1, the second electrode 138-1, the first electrode 136-2, and the second electrode 138-2 overlap each other in the z direction when these electrodes are virtually translocated parallel in the xy plane so as to overlap each other in the z direction.

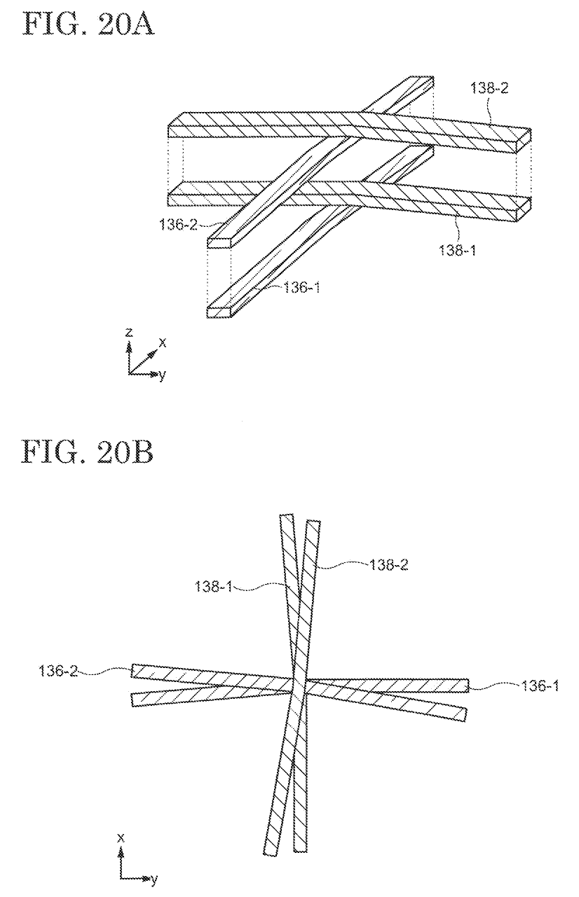

The same is applied when the first electrode 136-1, the second electrode 138-1, the first electrode 136-2, or the second electrode 138-2 has a bending structure. Specifically, as shown in FIG. 20A, the first electrode 136-1 and the first electrode 136-2 may completely overlap in the z direction, and/or the second electrode 138-1 and the second electrode 138-2 may completely overlap in the z direction. Alternatively, as shown in FIG. 20B, the first liquid crystal cell 130-1 and the second liquid crystal cell 130-2 may be configured and arranged so that two adjacent straight sections of the first electrode 136-1, two adjacent straight sections of the second electrode 138-1, the two adjacent straight sections of the first electrode 136-2, and two adjacent straight sections of the second electrode 138-2 all extend in different directions. In this case, the straight sections of the first electrode 136-1, the second electrode 138-1, the first electrode 136-2, and the second electrode 138-2 extend in different directions in the xy plane. In other words, when the first electrode 136-1, the second electrode 138-1, the first electrode 136-2, and the second electrode 138-2 are virtually translocated parallel so that the bending points overlap in the z direction, each straight section extends in a different direction in the xy plane.

The optical element 122 is thus configured so that the first electrodes 136 do not completely overlap and the second electrodes 138 also do not completely overlap in the z direction between the two liquid crystal cells 130, by which the interference of light caused by these electrodes is suppressed, and as a result, generation of variation in illuminance and chromaticity of the light emitted from the optical element 122 can be prevented. Hence, the colors of the light from the light source 110 can be correctly reproduced in the illuminated area.

### 2. Light Distribution Control by Optical Element

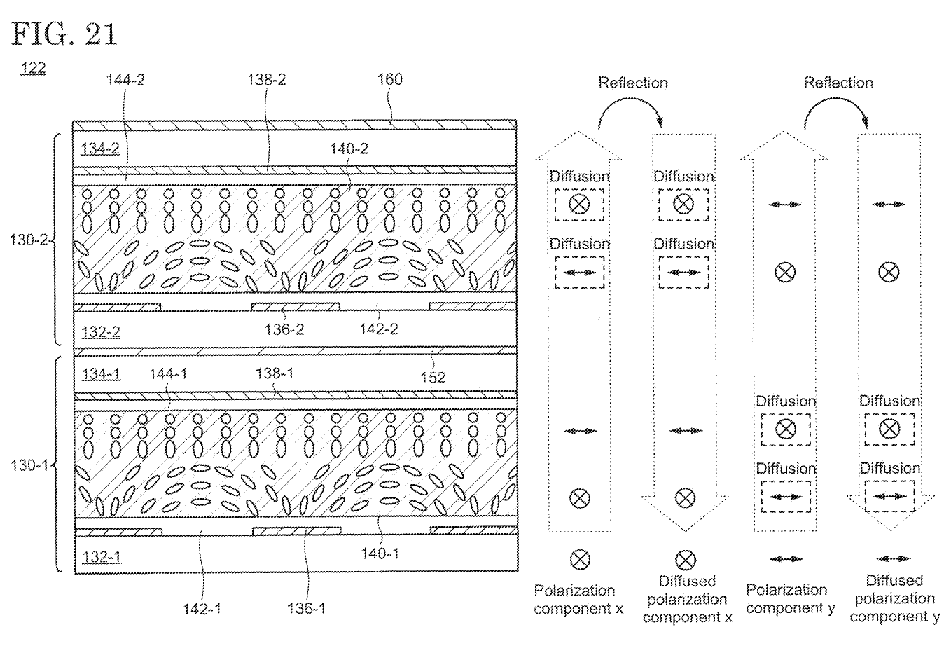

The use of the optical element 122 having two liquid crystal cells 130 enables the light to be diffused more effectively. For example, when all of the first electrodes 136 and the second electrodes 138 of the first liquid crystal cell 130-1 and the second liquid crystal cell 130-2 are driven as shown in FIG. 21, a refractive index distribution is generated in the liquid crystal layer 140-1 of the first liquid crystal cell 130-1 and the liquid crystal layer 140-2 of the second liquid crystal cell 130-2, similar to the first embodiment. Therefore, one of the polarization components of the light from the light source 110 (in this case, polarization component x) does not diffuse in the liquid crystal layer 140-1 and only optically rotates 90°, but diffuses in the x direction and the y direction while optically rotating 90° in the liquid crystal layer 140-2. This light is further reflected by the reflector 160, diffuses in the x direction and the y direction while optically rotating 90° again in the liquid crystal layer 140-2, and then optically rotates 90° without diffusing in the liquid crystal layer 140-1. As a result, the optical element 122 changes the incident polarization component x into a polarization component x diffused twice in the x direction and the y direction, respectively. The same is applied to the other polarization component of the light from the light source 110 (in this case, polarization component y), providing a polarization component y diffused twice in the x direction and the y direction, respectively.

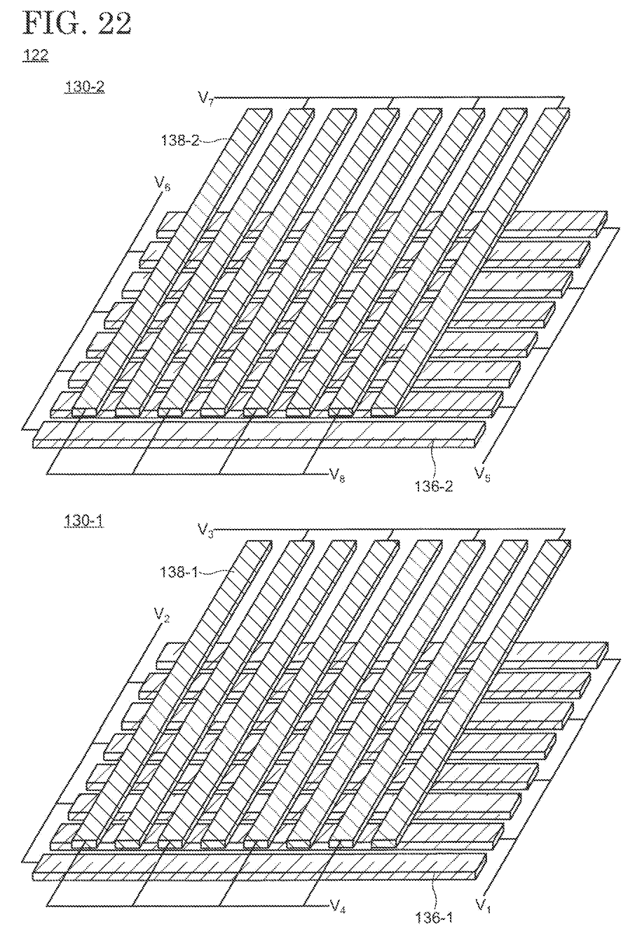

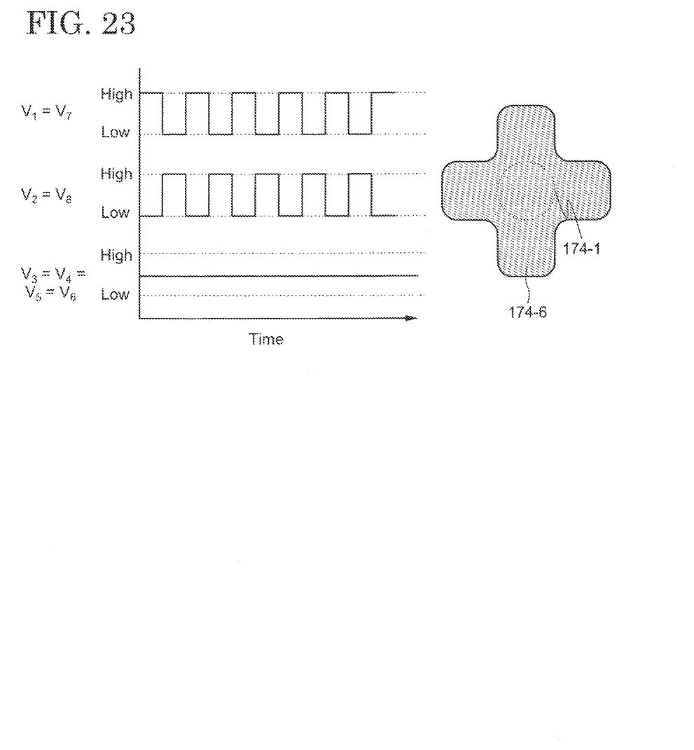

As described above, since the light from the light source 110 can be diffused several times (e.g., three or more times) in the x direction and the y direction, light coloration caused by insufficient diffusion can be suppressed. In addition, illuminated areas with a variety of shapes, such as circular, elliptical, and line shapes, can be obtained. For example, as shown in FIG. 22, a case is considered in which voltages V₁ and V₂ are alternately provided to the plurality of first electrodes 136-1 of the first liquid crystal cell 130-1, voltages V₃ and V₄ are alternately provided to the plurality of second electrodes 138-1 of the first liquid crystal cell 130-1, voltages V₅ and V₆ are alternately provided to the plurality of first electrodes 136-2 of the second liquid crystal cell 130-2, and voltages V₇ and V₈ are alternately provided to the plurality of second electrodes 138-2 of the second liquid crystal cell 130-2. As shown in FIG. 23, the voltages V₁ and V₇ are synchronized, the voltages V₂ and V₈ are set in an opposite phase with respect to the voltages V₁ or V₇, and the voltages V₃, V₄, V₅, and V₆ are set to be 0 or constant, by which the light emitted from the light source 110 and providing the circular illuminated area 174-1 can be processed to light providing a cross-shaped illuminated area 174-6. The length of the cross-shaped branches can be controlled by modifying the magnitude of the voltages V₁, V₂, V₇, and V₈ as appropriate.

### 3. Modified Examples

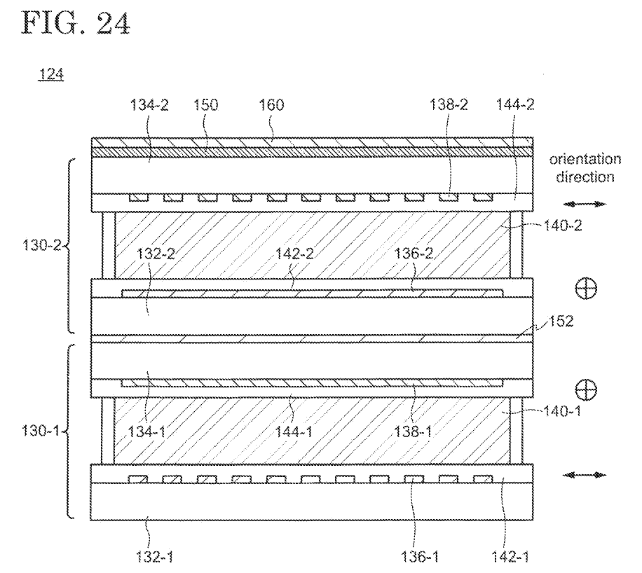

The configurations of the optical elements according to the embodiments of the present invention are not limited to those described above. For example, as demonstrated by an optical element 124 according to this modified example depicted in FIG. 24, the first liquid crystal cell 130-1 and the second liquid crystal cell 130-2 may be arranged so that the extending direction of the first electrodes 136-1 of the first liquid crystal cell 130-1 is perpendicular to or intersects the extending direction of the first electrodes 136-2 of the second liquid crystal cell 130-2 at an angle equal to or larger than 80° and equal to or smaller than 90°. In this configuration, the extending direction of the second electrodes 138-1 of the first liquid crystal cell 130-1 is also perpendicular to or intersects the extending direction of the second electrodes 138-2 of the second liquid crystal cell 130-2 at an angle equal to or larger than 80° and equal to or smaller than 90°. Furthermore, the λ/4 film 150 is also disposed similar to the optical element 120. Although not illustrated, the optical element 124 may also include the antireflection film 166 on the bottom side of the substrate 132 of the first liquid crystal cell 130-1.

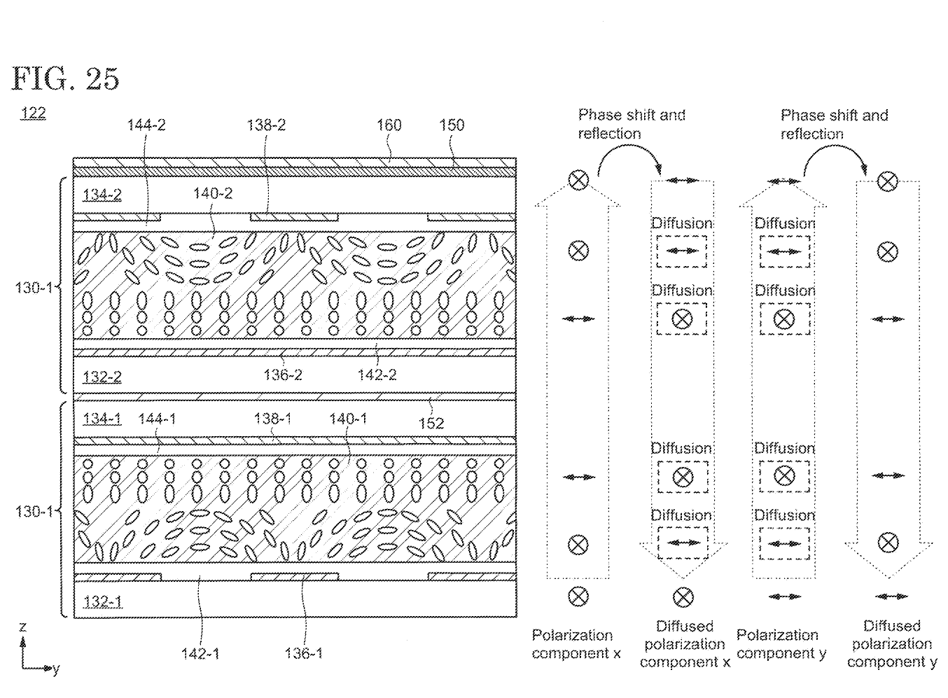

As shown in FIG. 25, in optical element 124, when both the first electrodes 136 and the second electrodes 138 of the first liquid crystal cell 130-1 and the second liquid crystal cell 130-2 are driven, the polarization component x of the light incident from the light source 110 is only optically rotated 90° by the liquid crystal layer 140-1 and liquid crystal layer 140-2. However, this light changes into the polarization component y when this light passes through the λ/4 film 150 and passes through the λ/4 film 150 again after being reflected on the reflector 160. When this polarization component y passes through the liquid crystal layer 140-2 and liquid crystal layer 140-1 in this order again, this light is diffused in the x direction and the y direction in each of the liquid crystal layer 140-2 and liquid crystal layer 140-1 to provide a diffused polarization component x. The same is applied to the polarization component y of the light from the light source 110. This light is diffused in the y direction and the x direction by each of the liquid crystal layer 140-1 and the liquid crystal layer140-2 when it enters the optical element 122, and is optically rotated 90° by the liquid crystal layer 140-1 and the liquid crystal layer 140-2 after being reflected by the reflector 160, providing a polarization component y. Thus, in the optical element 124, each polarization component is diffused by both the first liquid crystal cell 130-1 and the second liquid crystal cell 130-2. Therefore, the optical element 124 is configured so that the first electrodes 136 do not completely overlap and the second electrodes 138 also do not completely overlap in the z direction between the two liquid crystal cells 130 as described above (see FIG. 19B and FIG. 20B), by which a lighting device in which generation of variation in illuminance and chromaticity is effectively suppressed can be provided.

Therefore, similar to the optical element 122, the light from the light source 110 can be diffused several times (e.g., diffused three or more times) in the x direction and the y direction, by which illuminated areas having a variety of shapes, such as circular, elliptical, and line shapes, as well as a larger illuminated area can be obtained. It is also possible to suppress light coloration caused by insufficient diffusion.

As described above, the light from light source 110 can be processed into light providing arbitrary illuminated areas with fewer liquid crystal cells than conventional optical elements by using the optical elements 120, 122, and 124. Particularly, the use of the optical elements 122 and 124 enables multiple light diffusion with two liquid crystal cells 130, thereby suppressing coloration of the processed light. Hence, the lighting device 100 including the optical element 120, 122, or 124 according to an embodiment of the present invention is able to function as a lighting device capable of providing a variety of illuminated areas.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of the display device of each embodiment is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. An optical element comprising:
a liquid crystal cell;
a λ/4 film over the liquid crystal cell; and
a reflector over the λ/4 film,
wherein the liquid crystal cell comprises:
a plurality of first electrodes extending in a first extending direction and arranged in a stripe shape;
a first orientation film over the plurality of first electrodes;
a liquid crystal layer located over the first orientation film and including liquid crystal molecules;
a second orientation film over the liquid crystal layer; and
a plurality of second electrodes located over the second orientation film, arranged in a stripe shape, and extending in a second extending direction intersecting the first extending direction at an angle equal to or larger than 80° and equal to or smaller than 90°.

2. The optical element according to claim 1,
wherein the first orientation film and the second orientation film are configured to respectively orient the liquid crystal molecules in a first orientation direction and a second orientation direction intersecting each other in the absence of an electric field,
the first orientation direction intersects the first extending direction at an angle equal to or larger than 80° and equal to or smaller than 90°, and
the second orientation direction intersects the second extending direction at an angle equal to or larger than 80° and equal to or smaller than 90°.

3. The optical element according to claim 1,
wherein the plurality of first electrodes is configured to be applied with a first alternating voltage which is inverted in phase between adjacent first electrodes, and
the plurality of second electrodes is configured to be applied with a second alternating voltage which is inverted in phase between adjacent second electrodes.

4. A lighting device comprising:
the optical element according to claim 1; and
a light source configured to irradiate the reflector with light through the liquid crystal cell.

5. An optical element comprising:
a first liquid crystal cell;
a second liquid crystal cell over the first liquid crystal cell; and
a reflector over the second liquid crystal cell,
wherein each of the first liquid crystal cell and the second liquid crystal cell comprises:
a plurality of first electrodes arranged in a stripe shape;
a first orientation film over the plurality of first electrodes;
a liquid crystal layer located over the first orientation film and including liquid crystal molecules;
a second orientation film over the liquid crystal layer; and
a plurality of second electrodes located over the second orientation film, arranged in a stripe shape, and intersecting the plurality of first electrodes at an angle equal to or larger than 80° and equal to or smaller than 90°.

6. The optical element according to claim 5,
wherein, in each of the first liquid crystal cell and the second liquid crystal cell,
the first orientation film and the second orientation film are configured to respectively orient the liquid crystal molecules in directions intersecting each other at an angle equal to or larger than 80° and equal to or smaller than 90° in the absence of an electric field,
the direction in which the first orientation film orients the liquid crystal molecules in the absence of an electric field intersects a direction in which the plurality of first electrodes extends at an angle equal to or larger than 80° and equal to or smaller than 90°, and
the direction in which the second orientation film orients the liquid crystal molecules in the absence of an electric field intersects a direction in which the plurality of second electrodes extends at an angle equal to or larger than 80° and equal to or smaller than 90°.

7. The optical element according to claim 5,
wherein an angle between a direction in which the plurality of first electrodes of the first liquid crystal cell extends and a direction in which the plurality of first electrodes of the second liquid crystal cell extends is equal to or larger than 0° and equal to or smaller than 10°.

8. The optical element according to claim 5, further comprising a λ/4 film between the second liquid crystal cell and the reflector,
wherein an angle between a direction in which the plurality of first electrodes of the first liquid crystal cell extends and a direction in which the plurality of first electrodes of the second liquid crystal cell extends is equal to or larger than 80° and equal to or smaller than 90°.

9. The optical element according to claim 5,
wherein, in each of the first liquid crystal cell and the second liquid crystal cell,
the plurality of first electrodes is configured to be applied with a first alternating voltage which is inverted in phase between adjacent first electrodes, and
the plurality of second electrodes is configured to be applied with a second alternating voltage which is inverted in phase between adjacent second electrodes.

10. A lighting device comprising:
the optical element according to claim 5; and
a light source configured to irradiate the reflector with light through the first liquid crystal cell and the second liquid crystal cell.
